(19) United States
(12) Patent Application Publication
(10) Pub. No.: US 2009/0019777 A1
(43) Pub. Date: Jan. 22, 2009

(54) Device for pivoting a lid

(75) Inventors: Thomas Flesch, Rheinbollen (DE); Gerhard Stein, Salz (DE); Christoph Ulrich, Boppard (DE); Jorg Wolf, Urmitz (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/156,618

(22) Filed: Jun. 3, 2008

(30) Foreign Application Priority Data
Jun. 5, 2007 (DE) 10 2007 026 230.4

(51) Int. Cl. E05F 1/10; E05F 3/02

(52) U.S. Cl. 49/386; 267/225

(57) ABSTRACT

A device is provided for pivoting a lid, especially a motor vehicle lid, around a pivot axis. The pivoting device has a first actuating unit on one side of the lid and a second actuating unit on the opposite side of the lid. The two actuating units have substantially the same drive forces in a first section of the lid travel distance and different drive forces in a second section of the lid travel distance.

### BACKGROUND OF THE INVENTION

1. Field of the Invention

The invention relates generally to a device for pivoting a lid, especially a motor vehicle lid, which can pivot around a pivot axis. In particular, the invention relates to a pivoting device having a first actuating unit on one side of the lid and a second actuating unit on the opposite side of the lid.

2. Description of the Related Art

Lid pivoting devices have been used for many years in the automobile industry. The operation of a lid, especially the rear lid in automotive applications, is preferably assisted by the force of tension springs, compression springs, or gas springs. In addition to providing such assistance to make it possible to raise and lower the lid conveniently, a gas spring or a gas damper can also be provided for velocity control and damping assistance.

In rear lid applications, when tension springs (energy-storage devices) increasing the force are used together with gas springs or gas dampers to control the lid opening movement, these elements counteract with each other. The resultant force acting on a lid hinge is equal to the difference between the force of the tension spring and the force of the damper. In a typical rear lid application, preferably two springs are used, one for each lid hinge. For the damping operation, one gas spring or one gas damper is sufficient. This means that the force of the tension spring minus the damper force acts on one side of the rear lid, whereas only the force of the tension spring acts on the other side of the rear lid. The difference in the forces acting on the hinges can cause certain distortion in the rear lid, which, when the lid is closed, makes the dimensions of various joints different from each other.

### SUMMARY OF THE INVENTION

An object of the present invention is to avoid the above described disadvantages and provide a low-cost device for pivoting a lid, which ensures that, when the lid is closed, the joints appear uniform and the wear on the hinges is reduced.

This object is accomplished by employing two actuating units having substantially the same drive forces in a first section of the lid travel distance and different drive forces in a second section of the lid travel distance. The first section of the lid travel distance can correspond to an area that is substantially the same as the lid travel distance for a closed lid. Alternatively, the first section of the lid travel path can extend into an area corresponding to the lid travel distance for an essentially completely opened lid.

Each of the actuating units comprises a spring device. One of the actuating units comprises a spring device with a tensile force and a piston-cylinder unit with a compressive force. The piston-cylinder unit preferably comprises a gas spring. Alternatively, the piston-cylinder unit can comprise a damper, where the damper can also provide an outward-pushing force. According to another preferred embodiment, the piston-cylinder unit has a spring device, which acts in opposition to the compressive force. The spring device of the piston-cylinder unit preferably acts in the area corresponding to the first section of the lid travel distance.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The invention is explained in greater detail below in connection with the drawing figures, in which:

FIG. 1 shows a perspective view of a section of the rear area of a motor vehicle with a device for pivoting a lid;

FIG. 2 shows a cross section of one of the actuating units;

FIG. 3 shows a diagram of force curves versus the opening angle of a lid according to the prior art; and

FIG. 4 shows a diagram of force curves versus the opening angle of a lid according to the present invention.

### DETAILED DESCRIPTION OF THE PRESENTLY PREFERRED EMBODIMENTS

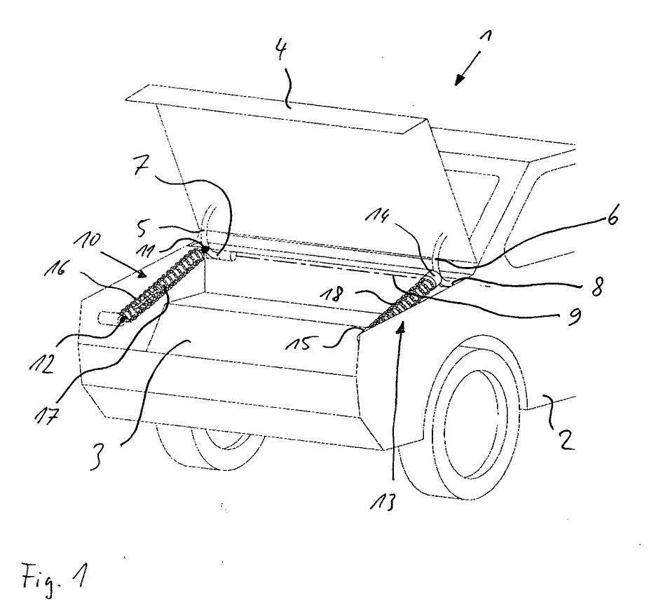

FIG. 1 shows a motor vehicle 1 having a body 2 and a lid 4, which closes a trunk space 3. The lid 4 is hinged pivotably around a pivot axis 9 by means of two pivot yokes 5 and 6 and two pivot hinges 7 and 8, mounted on the body 2.

A first actuating unit 10 is hinged rotatably to the body 2. The first actuating unit 10 is connected at one end to a connecting element 11 on the pivot yoke 5, whereas the other end of the actuating unit 10, i.e., the end opposite the connecting element 11, is connected to an additional connecting element 12 inside the trunk space 3.

A second actuating unit 13 is also hinged rotatably to the body 2. The second actuating unit 13 is connected at one end to a connecting element 14 on the pivot yoke 6, whereas the other end of the actuating unit 13, i.e., the end opposite the connecting element 14, is connected to an additional connecting element 15 inside the trunk space 3.

The first actuating unit 10 comprises a spring device 16, preferably designed as a helical tension spring, and a piston-cylinder unit 17 surrounded by the spring device 16. The second actuating unit 13 comprises a spring device 18, also preferably designed as a helical tension spring.

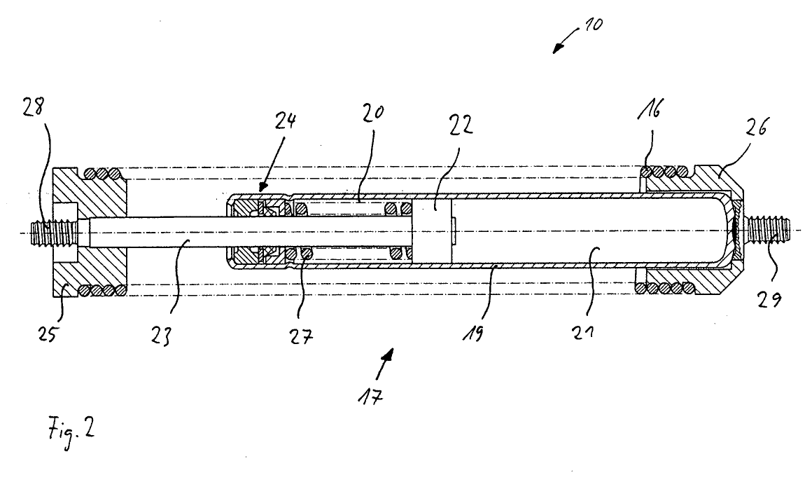

As is shown in FIG. 2, the piston-cylinder unit 17 can comprise a preferably pressurized fluid-filled cylinder 19 and a piston 22 dividing the cylinder 19 into a first working chamber 20 and a second working chamber 21. A piston rod 23 is attached to the piston 22. The piston rod 23 extends through the first working chamber 20 and out of the cylinder 19 through a guide and sealing package 24.

The piston-cylinder unit 17 can have one or more throttle devices (not shown), which may, for example, comprise channels or bores in the piston 22 and/or one or more axial grooves in the inside surface of the cylinder 19.

A first spring mounting part 25 is provided at the free end of the piston rod 23. On the end of the cylinder 19 opposite the free end of the piston rod 23, there is another spring mounting part 26. The spring mounting parts 25, 26 connect the spring device 16 to the piston-cylinder unit 17.

A thread 28 is formed on the free end of the piston rod 23, while a thread 29 is formed on a remote end of the cylinder 19. Connecting elements 11 and 12 (see, FIG. 1), for example, ball sockets or as joint eyes, can be provided and screwed onto these threads 28, 29.

A spring device 27 is provided between the guide and sealing package 24 and the piston 22 and can comprise, for example, a compression spring, one or more disk springs, or other elastic spring elements. The spring device 27 acts in opposition to the compressive force or outward-pushing force of the piston-cylinder unit 17.

FIG. 3 shows a diagram in which the force is plotted against the lid travel distance. The left side of the curves, where the spring forces are the lowest, corresponds to an open state of the lid 4. The right side of the curves, where the spring forces are the highest, corresponds to a closed state of the lid 4. The force curve 30 shows the change in the force of the piston-cylinder unit 17 mounted in the first actuating unit 10, relative to the lid travel distance. The force curve 31 shows the change in the force of the first actuating unit 10, which contains the spring device 16 together with the piston-cylinder unit 17, relative to the lid travel distance. The force curve 32 shows the change in the force of the second actuating unit 13. As FIG. 3 shows, the difference between the force values of force curves 32 and 31 corresponds to the force values of the force curve 30.

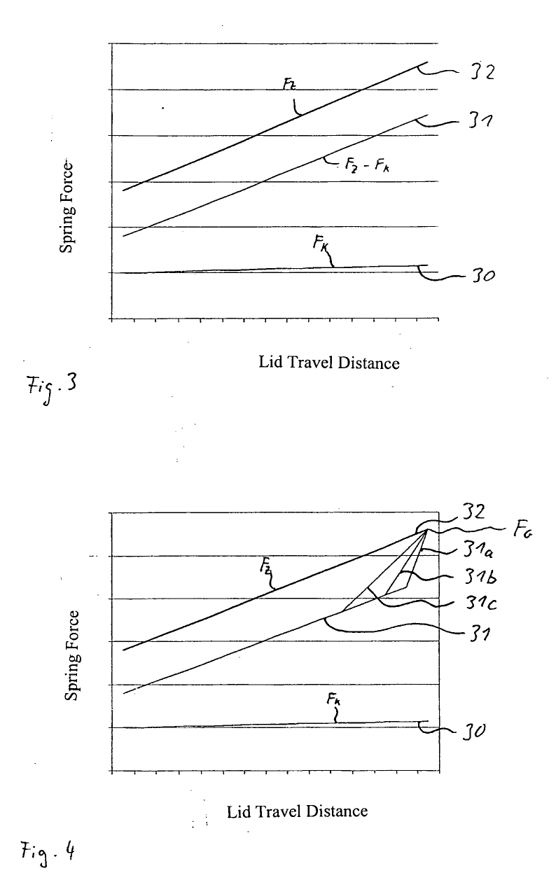

FIG. 4 shows another diagram, in which force curves 30 and 32 are the same as those shown in FIG. 3 and are thus designated by the same reference numbers. The force curve 31 in FIG. 4 shows the change in the force of a first actuating unit 10, in which the spring device 27 is installed in the piston-cylinder unit 17. The force curve sections 31a, 31b, 31c correspond to the force curves of different spring devices 27.

When the piston 22 moves toward the thread 29 on the cylinder 19, a spring device 27 yielding the force curve section 31b exerts a force on the piston 22 over a longer distance comparing to a spring device 27 yielding the force curve section 31a. A spring device 27 yielding the force curve section 31c exerts a force on the piston 22 over a longer distance comparing to a spring device 27 yielding the force curve section 31a or 31b.

The force F_{K} of the piston-cylinder unit 17 in the outward-extended position can be in the range of 100-120 N. This force is provided to ensure leak-tightness and damping properties. The piston-cylinder unit 17 exerts its force F_{K} in the outward-travel direction, whereas the spring device 16, such as a tension spring, counteracts with a force F_{Z}, thus providing a pulling effect, or a pushing-in effect relative to the piston-cylinder unit 17. The total effective force F_{G} acting on the side of the lid where the actuating unit 10 is located is therefore smaller by the force F_{K} than the force F_{Z} on the side of the lid where the actuating unit 13 is located.

To cancel out this effect, i.e., to raise the force F_{G} to the force F_{Z}, the spring element 27 is installed in the piston-cylinder unit 17. This spring element 27 is positioned between the guide and sealing package 24 and the piston 22. When the rear lid 4 is being closed, the length of the actuating device 10 and thus of the spring device 16 and of the integrated piston-cylinder 17 increases. The spring device 27 integrated into the piston-cylinder 17 is compressed and generates a compressive force F_{D} acting on the side of the piston 22 facing the piston rod 23. In one example, the compressive force F_{D} can be as large as the outward-pushing force F_{K} of the piston-cylinder unit 17 acting on the side of the piston 22 facing away from the piston rod 23. Thus an equilibrium of forces is produced in the outward-pushing position of the first actuating unit 10.

The spring device 27 integrated into the piston-cylinder unit 17 acts preferably only in the area in which the piston-cylinder 17 is pushed out. When the piston-cylinder unit 17 is pulled in or compressed, the spring element 27 relaxes, and the force F_{K}, which is a result of the pressure acting on the side of the piston 22 facing away from the piston rod 23, goes into effect.

Depending on the application, the force F_{D} of the spring device 27 can also be greater or less than the outward-pushing force F_{K} generated in the piston-cylinder unit 17.

Additionally or alternatively, the additional force F_{D} of the spring device 27 acting via the stroke of the piston-cylinder unit 17 can be variable. Although the force F_{D} is preferably active in the outward-pushed or extended position of the piston-cylinder 17, the force F_{D} can be exerted over the entire stroke of the piston-cylinder unit 17 to achieve, for example, a constant manual force level.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for pivoting a lid around a pivot axis, the lid being pivotable through first and second sections of a lid travel distance, the device comprising:
a first actuating unit acting on one side of the lid, and
a second actuating unit acting on an opposite side of the lid,
wherein the two actuating units have substantially same drive forces in the first section of the lid travel distance about the pivot axis and different drive forces in the second section of the lid travel distance about the pivot axis.

2. The device according to claim 1, wherein the first section of the lid travel distance corresponds to an area corresponding substantially to the lid travel distance for a closed lid.

3. The device according to claim 1, wherein the first section of the lid travel distance extends into an area corresponding to the lid travel distance for a completely opened lid.

4. The device according to claim 1, wherein each of the actuating units comprises a spring device.

5. The device according to claim 1, wherein one of the actuating units comprises a spring device with a tensile force and a piston-cylinder unit with a compressive force.

6. The device according to claim 5, wherein the piston-cylinder unit comprises a gas spring.

7. The device according to claim 5, wherein the piston-cylinder unit comprises a damper.

8. The device according to claim 5, wherein the piston-cylinder unit has a spring device acting in opposition to the compressive force.

9. The device according to claim 8, wherein the spring device of the piston-cylinder unit generates an counteracting force having a same value as that of the compressive force.

10. The device according to claim 8, wherein the spring device of the piston-cylinder unit operates in an area corresponding to the first section of the lid travel distance.

11. The device according to claim 8, wherein the spring device of the piston-cylinder unit operates in an area corresponding to the entirety of the lid travel distance.

12. The device according to claim 8, wherein the spring device of the piston-cylinder unit is a compression spring.

13. The device according to claim 8, wherein the piston-cylinder unit comprises:
a cylinder,
a piston positioned inside the cylinder and divide the cylinder into first and second working chambers,
a piston rod connected to the piston and extending through the first working chamber and outside the cylinder,
wherein the spring device is positioned in the first working chamber.

14. The device according to claim 13, wherein the cylinder contains a pressurized fluid.
